(19) United States
(12) Patent Application Publication
(10) Pub. No.: US 2011/0282685 A1
(43) Pub. Date: Nov. 17, 2011

(54) Method and Apparatus Pertaining to Developing Care Paths

(75) Inventors: Juha Kauppinen, Espoo (FI); Janne Nord, Espoo (FI)

(73) Assignee: Varian Medical Systems International AG, Zug (CH)

(21) Appl. No.: 12/777,404

(22) Filed: May 11, 2010

(51) Int. Cl. G06Q 50/00

(52) U.S. Cl. 705/3

(57) ABSTRACT

A control circuit develops, in parallel, a plurality of care paths for at least one corresponding patient. This can comprise, for these care paths, serially completing a plurality of corresponding care-path-development phases (using, for example, input information of choice). Then, pursuant to these teachings and before concluding development of at least one of these care paths (and upon determining a change to the aforementioned input information during the developing process), automatically modifying at least one of the care-path-development phases as a function of the change and redeveloping the care plan as corresponds to the modified care-path-development phase.

### TECHNICAL FIELD

This invention relates generally to developing care paths such as, but not limited to, radiation-therapy treatment plans.

### BACKGROUND

Treating a physically-manifested malady does not ordinarily conclude with the diagnosis. This is at least in part because an effective treatment for the malady in question typically comprises a multi-dimensional consideration. Knowing, for example, that radiation exposure will serve to treat a tumor nevertheless begs the question of how to administer that treatment. Answering this question typically involves consideration of numerous factors involving the size and shape of the tumor, the nature and proximity of adjacent tissue, and a desired radiation dosage (with numerous other factors also being relevant to consider). These facts can then lead to consideration of specific angles of exposure, radiation pulse duration and intensity, radiation beam shaping, and so forth.

It is known in the art to utilize computer-based processing to iteratively develop a particular treatment plan for a given patient. In more complicated application settings this often comprises serially completing a plurality of care-path-development phases using corresponding input information regarding, for example, the patient, the treatment apparatus, and/or various operational treatment settings and parameters. If desired, the resultant plan can then be compared against other similarly generated plans in order to identify a likely best plan to employ for a given patient.

Unfortunately, the aforementioned approach can be highly computationally intensive. This, in turn, can require time and/or computational resources that are not practically met in all settings. In some cases such requirements can be alleviated to some extent by helpful intervention from time to time on the part of a skilled technician. Unfortunately, existing approaches in these regards are not user friendly. As a result, it can be difficult to ensure that an end user will interact in both a useful and timely manner with the execution of such a process.

### BRIEF DESCRIPTION OF THE DRAWINGS

The above needs are at least partially met through provision of the method and apparatus pertaining to developing care paths described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a schematic representation of a screen shot as configured in accordance with various embodiments of the invention;

FIG. 4 comprises a screen shot as configured in accordance with various embodiments of the invention; and

FIG. 5 comprises a screen shot as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit can develop, in parallel, a plurality of care paths for at least one corresponding patient. This can comprise, for these care paths, serially completing a plurality of corresponding care-path-development phases (using, for example, input information of choice). Then, pursuant to these teachings and before concluding development of at least one of these care paths (and upon determining a change to the aforementioned input information during the developing process), automatically modifying at least one of the care-path-development phases as a function of the change and redeveloping the care plan as corresponds to the modified care-path-development phase.

As noted, these teachings can be employed to develop care paths for a given patient. If desired, however, these teachings will also accommodate using this control circuit to develop, in parallel, care paths for a plurality of corresponding patients.

These teachings are highly flexible and will accommodate a variety of useful variations in these regards. By one approach, for example, the care-path-development phases can include at least one phase that includes applying a template having default treatment values, contouring a volume within the patient, and/or applying values from a previously completed care path, to note but a few useful possibilities in these regards.

These teachings will also accommodate, for example, automatically terminating further development of one or more of the aforementioned care paths as a function of development of another of the care paths. Such termination can take into account, for example, such considerations as a particular level (absolute or relative) of achieved quality, development time, and so forth.

Such approaches can readily accommodate accepting and making use of timely and well-informed user input if desired. To facilitate a better informed and more intuitive interaction in these regards, these processes will readily accommodate displaying processing and development information to an end user. This can comprise, for example, simultaneously displaying to the end user two or more of care path development progress, prospective care path development steps, the identification of care paths for which development will be undertaken, retrospective information regarding care path development, and information regarding care paths for which development has been terminated (to note but a few examples in these regards).

So configured, a considerable improvement with respect to the development of a suitable care path for a given patient can be achieved using presently available computational resources. These teachings are highly leveragable across a wide variety of care path paradigms and operational settings including, but not limited to, the development of radiation-therapy treatment plans. These teachings are also highly scalable and can be readily employed in conjunction with a wide variety of treatment possibilities, operational ranges, dosing parameters, treatment modalities, and so forth.

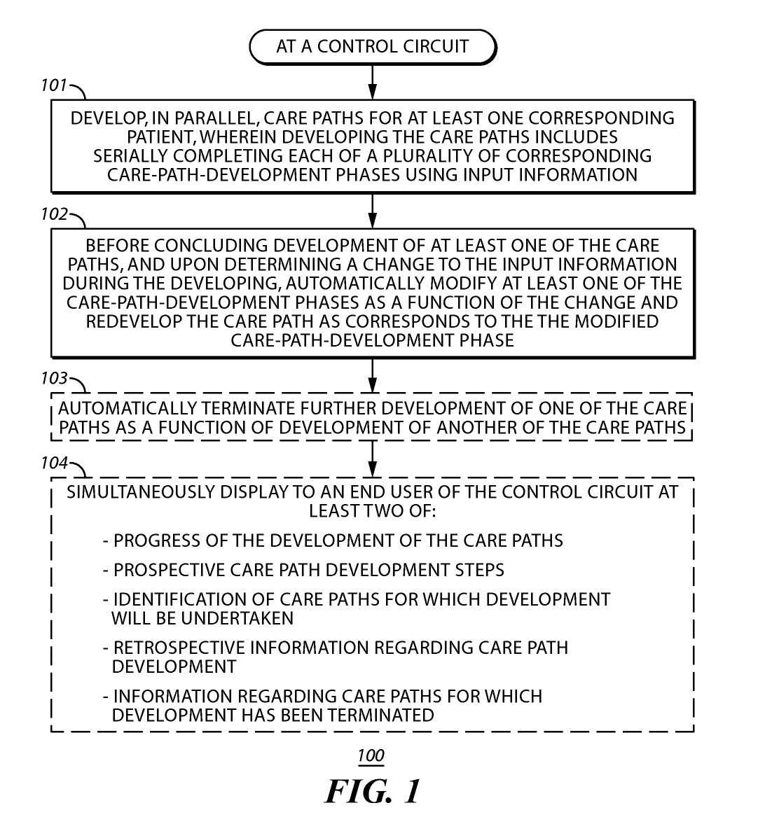

These and other benefits may become clearer upon making a thorough review and study of the following detailed description. Referring now to the drawings, and in particular to FIG. 1, an illustrative process 100 that is compatible with many of these teachings will now be presented.

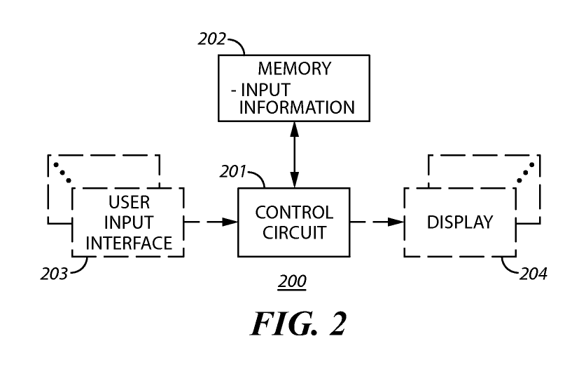

As alluded to above, this process 100 can be carried out by a corresponding control circuit. This control circuit can be realized using any of a wide variety of available and/or readily configured platforms, including partially or wholly programmable platforms as are known in the art or dedicated purpose platforms as may be desired for some applications. Referring momentarily to FIG. 2, an illustrative approach in these regards will now be provided.

In this illustrative example, a given care path determination apparatus 200 can comprise, at least in part, a control circuit 201 that operably couples to a memory 202 that serves to store input information suitable for use as per these teachings. This control circuit 201 can comprise a fixed-purpose hard-wired platform or can comprise a partially or wholly programmable platform. All of these architectural options are well known and understood in the art and require no further description here.

Generally speaking, this control circuit 201 can be configured (using, for example, corresponding programming as will be well understood by those skilled in the art) to carry out any one or more of the steps, actions, and/or functions described herein. To further facilitate matters, this control circuit 201 can optionally operably couple to one or more user input interfaces 203 (such as, but not limited to, alphanumeric keypads, cursor control devices, touch screens, voice recognition modules, and so forth) and one or more displays 204 (such as, but not limited to, cathode ray tubes displays, flat-panel displays, monochromatic displays, multi-color displays, and so forth). Generally speaking, these teachings are particularly useful when employed in conjunction with displays capable of presenting graphic and alphanumeric content.

Such an apparatus 200 may be comprised of a plurality of physically distinct elements as is suggested by the illustration shown in FIG. 2 It is also possible, however, to view this illustration as comprising a logical view, in which case one or more of these elements can be enabled and realized via a shared platform. It will also be understood that such a shared platform may comprise a wholly or at least partially programmable platform as are known in the art.

In any event, and referring again to FIG. 1, this process 100, at step 101, provides for developing, in parallel, care paths for at least one corresponding patient. This might comprise, for example, using an inverse planning approach to develop one or more of these care paths. This step 101 includes developing such care paths in a manner that includes serially completing a plurality of corresponding care-path-development phases using input information.

As used herein, the expression “care path” will be understood to refer to models of patient care, which models will typically (though not necessarily always) include specific elements of care and/or treatment that the patient is to receive. A useful, though non-exhaustive, example in these regards is a treatment plan as typifies the administration of radiation therapy (which plans often describe or correlate to a given field geometry and specify beam shapes and beam intensities at a sequence of various angles/times during the course of administering a given treatment). For the sake of illustration and simplicity, then, and without intending any limitations in these regards, it will be presumed for the purposes of this description that the care paths being developed as per this step 101 comprises care paths that specify applying therapeutic radiation (such as x-rays, proton beams, or the like) to the patient.

The aforementioned reference to developing such care paths in parallel is intended to refer to some degree of temporal coincidence. Accordingly, this notion of being “parallel” does not require that any such care path be determined, in its entirety, in a manner that is exactly and fully temporally coincident from start to finish with the determination of any other care path. Instead, generally speaking, this reference to “parallel” is intended to refer to the concept of working on a number of different care paths such that, for at least some instant in time, such development has begun but has not yet completed in more than one care path.

As mentioned, the development of these care paths is presumed to require, generally, serially completing a plurality of care-path-development phases. Illustrative examples in these regards can include, but are not limited to, phases pertaining to automatically segmenting specific identified volumes within the patient, optimizing a treatment sequence of control points for a corresponding treatment modality (such as, for example, Intensity-Modulation Radiation Therapy (IMRT) or so-called RapidArc therapy, to note but two examples in these regards), calculating a specific radiation-exposure dosage, and so forth. In many cases, at least some such phases will require, as an input to their own processing, the output of an earlier phase. For example, optimizing a treatment sequence of control points may first require the results of a preceding segmentation phase. Accordingly, these teachings will readily accommodate applying values from a previously-completed phase and/or even a previously-completed care path.

These teachings are readily employed in conjunction with a wide variety of such phases. By one approach, for example, one or more of the phases can include contouring a volume (such as a treatment volume) within the patient. By another approach, one or more of these phases can include applying a template having default treatment values. Such “templates” can of course vary with the application setting. By one approach, a template can contain information for developing a single phase. By another approach, a given template can contain information for developing an entire single care path. By yet another approach, a given template can contain information to be used for developing a plurality of the care paths (or even all of the care paths).

The “input information” referred to in step 101 can comprise information that is known a priori to initiation of the process 100. Such previously-known information can comprise, by one approach, earlier information developed for this particular patient (such as earlier Computed Tomography (CT) images for this patient, earlier treatment plans as were previously administered for this patient, and so forth), default information as serves to generally characterize a particular patient population, and so forth. In lieu thereof, or in combination therewith, such input information can comprise information developed during the course of carrying out step 101. For example, and as noted above, concluding a certain care-path-development phase for a given care path determination can yield results that can serve as “input information” for that given care path determination and/or for other care paths being determined pursuant to this step 101.

By one approach, these care paths can represent competing treatment approaches. In this case, this process 100 can serve to facilitate developing, from amongst a plurality of competing candidates, a particular preferred care path to accommodate the various circumstances as characterize a particular patient and the available treatment options. By one corresponding approach, then, at least some of these care-path development approaches can vary from one another by using, for example, differing optimization algorithms. As another example, at least some of these care-path development approaches can presume use of differing energy-application modalities (where, for example, one care path presumes the use of a first x-ray machine while another care path presumes the use of a second x-ray machine that is different from the first x-ray machine in any of a variety of ways).

It is also possible, however, to employ these teachings in other regards. For example, this process 100 can be employed to develop a specific approach to be utilized for a plurality of different treatment modalities (or different treatment phases) that are all to be used when treating a given patient. As another example in these regards, this process 100 can serve to provide a plurality of treatment approaches to accommodate a variety of patient geometries or other treatment circumstances that may not be immediately available at the time of developing these care paths. In such a case, when it does become possible to assess the presently unknown parameter(s) of interest, one can then select whichever of the developed care paths most closely correlates to that now-available information.

As noted earlier, this step 101 refers to developing, in parallel, a number of such care paths for at least one patient. If desired, this step 101 will accommodate taking such action on behalf of a plurality of patients. This can refer to serially developing a plurality of such care paths for a corresponding series of patients or effecting such developments in parallel for this plurality of patients. The needs of these patients can be as similar, or dissimilar, to one another as may be appropriate to the needs and/or opportunities of a given application setting. In some cases, for example, there may be an opportunity to leverage certain input information across multiple such patients.

In any event, this process 100 then provides for step 102. Pursuant to this step 102, before concluding development of at least one of the aforementioned care paths, and upon determining a change to the aforementioned input information during the developing contemplated by step 101, the control circuit automatically modifies at least one of the care-path-development phases as a function of the determined change. This, in turn, leads to redeveloping the care plan that corresponds to the modified care-path-development phase.

This “change” pertains to a change as regards the input information. As already noted above, this input information can comprise information as input (previously or during the carrying out of this process 100) by an end user or as input that comprises, for example, an output of one of the care-path-development phases and/or one of the care paths. Accordingly, this “change” can comprise, for example, fresh input from an end user or newly-available information comprising fresh output from a care-path-development phase.

Determining which care-path-development phase to so modify can itself be a function, for example, of meta-information that has been previously defined and rendered available to the control circuit when carrying out this process 100. This meta-information, in turn, can identify such things as dependencies between sets of information according to, for example, effective processes and their corresponding inputs and outputs.

As a very simple example in these regards, it can be known that a given care-path-development phase serves to provide, as its output, information regarding the contour of the patient's treatment volume. When a different care-path-development phase provides this same contour information (though using, perhaps, a different methodology to derive the information) before the given care-path-development phase can achieve the answer, the given care-path-development phase can be “modified” by being halted as the required information is now otherwise available.

Even this simple example suggests certain benefits of these teachings. In particular, in this example, any of the care path developments of step 101 that are striving to derive a particular item of information can cease striving in those regards when the information becomes available in some other way (for example, from the parallel efforts to develop other care paths, from the end user, or otherwise).

Accordingly, it will be understood that the specific modification as occurs pursuant to step 102 can and will vary with respect to the application setting and with respect to the opportunities and/or limitations as tend to characterize that application setting. Exemplary modifications include, but are certainly not limited to, deleting a given care-path-development phase, restarting a given care-path-development phase (including restarting a care-path-development phase that has already been carried to completion) (to begin anew, for example, with the changed input information or with other information that has now changed as a result of the determined change to the input information), changing one or more parameters, mid-stream, of a presently executing care-path-development phase, skipping a not-yet-executed care-path-development phase, and so forth.

This process 100 will readily accommodate repeating step 102 many times over as various changes to the input information may justify such modifications. As a result, the parallel development of these different care paths on a phase-by-phase basis can result, if desired, in a high degree of interactivity where the success of one phase can be leveraged, more or less in real time, across one or more other developing care paths.

As a net result and benefit, these teachings can result in more quickly finding one or more optimum care paths for a given patient (or for a group of disparate patients) than might otherwise be expected when relying upon prior art approaches in these regards. In some cases (for example, when vetting a plurality of alternatives to identify a given approach that will meet some predetermined measure of expected success), this process 100 can alternatively accommodate a step 103 to provide for automatically terminating further development of one or more of the care paths as a function of having developed another of the care paths. Using this approach, for example, in addition to potentially hastening the development of one or more of the candidate care paths, an early success in identifying a particular care path that meets some predetermined criterion can result in early termination of the entire overall development process.

By one approach, the control circuit 201 can simply provide one or more fully developed care paths as its output. These results can be displayed, printed, or stored as desired.

If desired, however, these teachings will optionally accommodate displaying various kinds of interim results and/or input opportunities to thereby invite and/or inform or otherwise accommodate inputs from the end user. As one illustrative expression in these regards, this process 100 will optionally accommodate a step 104 providing for simultaneously displaying (to an end user of the control circuit 201) at least one of:

Progress of the development of the care paths (individually and/or in the aggregate);

Prospective care path development steps (i.e., scheduled steps not yet executed);

Identification of care paths for which development will be undertaken (either prospectively or presently in progress);

Retrospective information regarding care path development (such as, but not limited to, which phases are complete, the deterministic results yielded by certain phases, time spent executing a given phase, and so forth); and/or

Information regarding care paths for which development has been terminated.

By one approach, this can comprise displaying this or other information (at least in part) on a care-path-development phase by care-path-development phase basis.

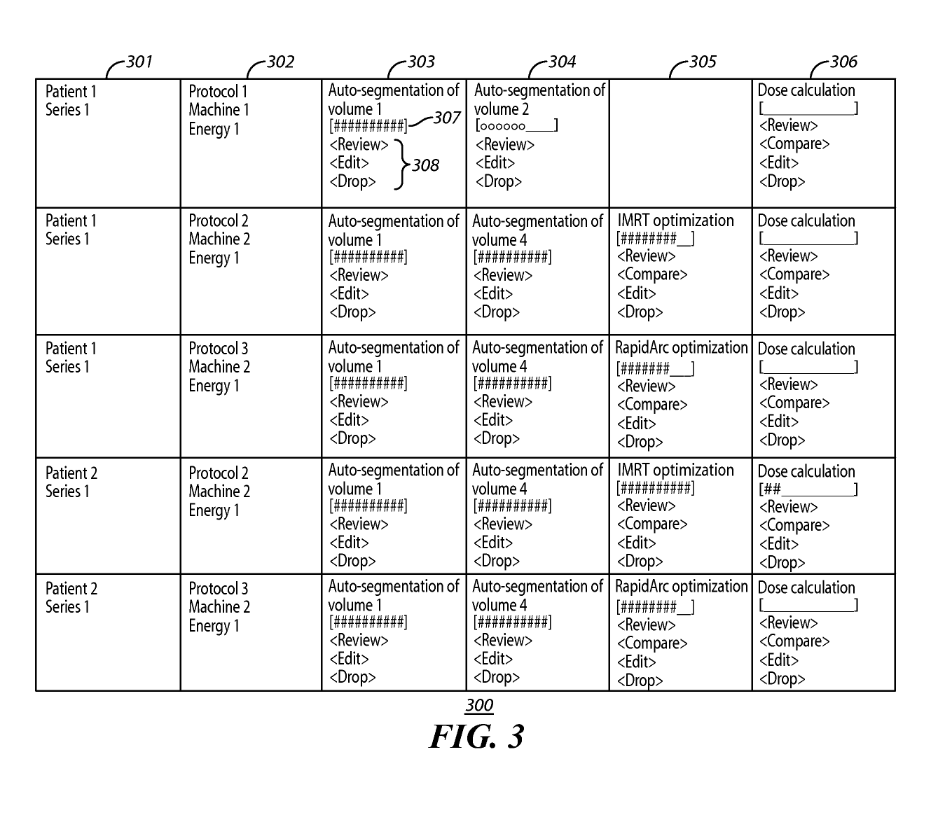

FIG. 3 provides a schematic view that illustrates certain approaches that accord with these teachings in these regards. Here, the display 300 presents five rows of information. A first column 301 denotes the subject of each row. In this illustrative example, the first three rows pertain to a first patient (Patient 1) and the last two rows pertain to a second, different patient (Patient 2). The second column 302 identifies general treatment parameters that govern the care path to be developed. For example, the first row presumes the use of Protocol 1 in conjunction with Machine 1 (such as a particular IMRT machine) and Energy 1 while the second row presumes, for the same patient, the use of a different protocol (Protocol 2) in conjunction with a different machine (Machine 2) and a similar energy (Energy 1).

The third through sixth columns 302-306 in this example pertain to various sequentially-executed phases that collectively lead to determination of a corresponding care plan. Here, the first phase 302 comprises automatically segmenting a given patient volume. If desired, the display provides a corresponding progress meter 307 to indicate the state of progress for the corresponding phase of each row. User-selectable buttons may also be provided for each phase to permit an end user to select particular actions. In this illustrative example, these selectable actions include reviewing particular aspects of the activities as comprise the phase, editing those aspects (for example, by providing input comprising course or fine tuning of the segmentation process), and/or dropping the phase (for example, to permit the corresponding care-plan development activity to make use of substitute input from another source).

The column 304 pertaining to the second phase provides, in turn, for auto-segmentation of other selected volumes of interest. Similar progress indicators and end-user selectable buttons are provided as were described above.

In this example, the next column 305 is empty for the first row as there is no counterpart phase to present for this particular care plan. The remaining rows, however, have an optimization phase represented in this column 305. The second row, for example, has an IMRT optimization phase while the third row (for the same patient) accommodates a RapidArc optimization phase. Again, these phases are presented with progress meters and various user-selectable buttons (including, here, a Compare instruction to accommodate, for example, performing a comparison as between the different care paths (where the information compared can comprise, for example, simulated dose distributions in relation to patient anatomy, statistical information about simulated dose distributions for volumes of interest, estimated biological responses, specialized plan quality metrics, treatment time, treatment complexity, the number of monitor units delivered to the patient, and so forth)).

The last column 306 in this example represents the dose calculation phase for each of the care plans.

In the example provided, it can be seen that the first phase has been completed for each of the care plans and that the second phase has been completed for all but the care plan that corresponds to the first row. The remaining care plans are currently engaged in executing their third phases with the exception of the care plan represented by the fourth row where it can be seen that the IMRT optimization phase is complete and that the dose calculation phase is underway for this particular care plan.

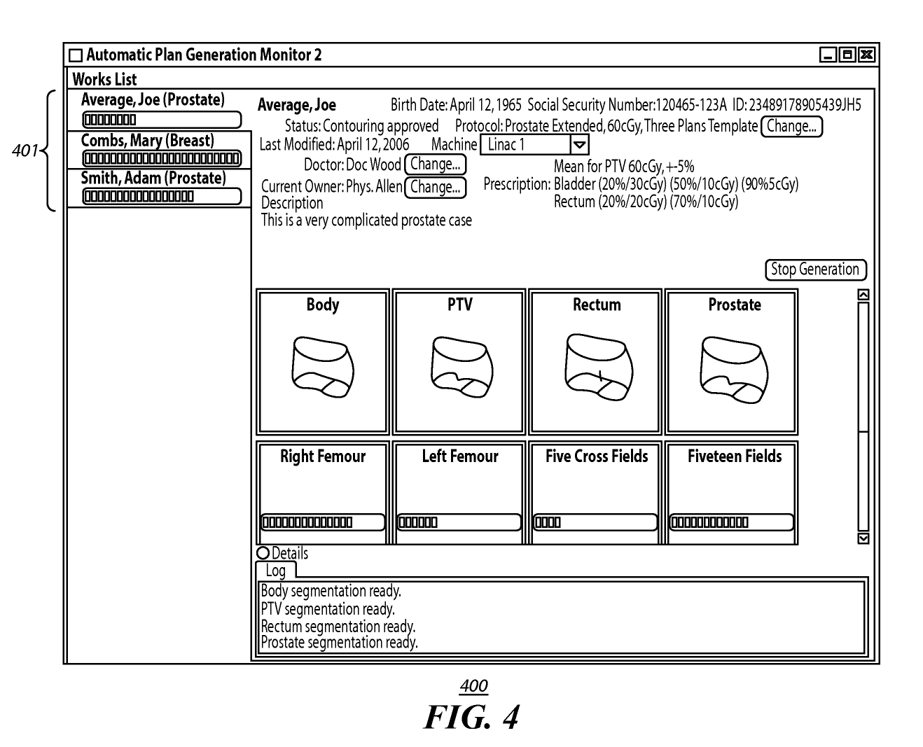

Referring now to FIG. 4, a different illustrative example in these regards will be presented. In this illustrative screenshot, progress meters 401 for three different patients indicate the relative progress as regards development of their corresponding care plans. By clicking on the name for the first patient (named Joe Average) the remaining portion of the display presents information regarding the care-plan development process for that particular patient. On the left in this illustrative example are tabs for each patient for whom the care path generation is running or has been run. Here, the first patient's tab has been selected and selected information about the patient is shown on the main part of the display. This information contains a real-time display of the care path generation phases and their current status. In the example illustrated, the care path generation phases comprise six automated structure definition procedures for individual volumes in patient, with two treatment plans being generated.

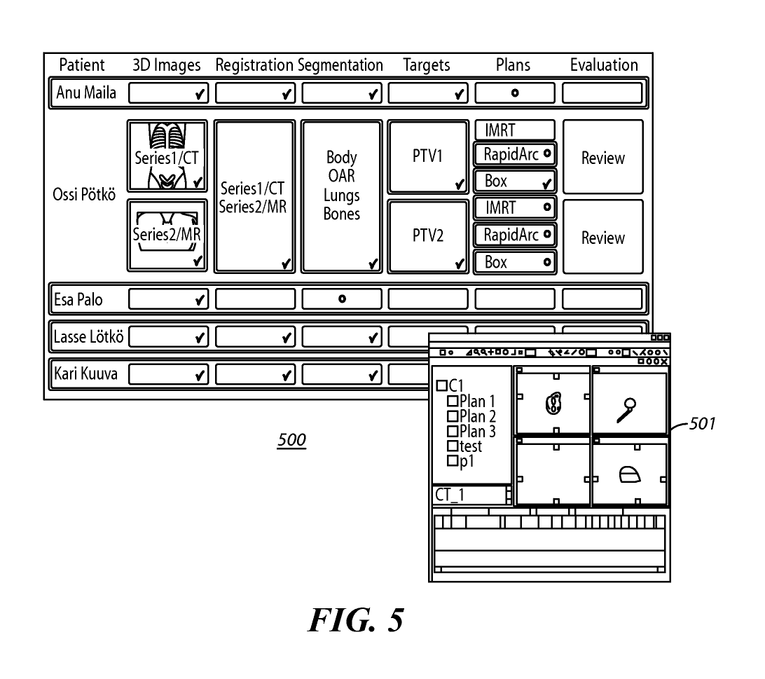

Referring now to FIG. 5, this illustrative screen shot 500 again demonstrates that information can be displayed in a row-by-row basis for various patients, with these rows being parsed into a plurality of columns that correspond to various phases (that each comprise, in this example, segregated automated tasks) that serve, in the aggregate, to facilitate development of a corresponding care plan. The information depicted can include, if desired, thumbnail depictions of relevant images (such as CT scans or the like).

In this example, the end user has the option of selecting a particular phase by clicking in the relevant row/column using a cursor control mechanism, a touch screen, or the like. This, in turn, will provide a more detailed corresponding view such as the one denoted here by reference numeral 501. This more detailed view can provide information, for example, regarding the details of the automated process or processes that comprise the underlying task. This more detailed view can also provide an interface to permit the end user to selectively alter or otherwise control or guide the automated process.

So configured, an end user can see useful information as pertains to the present and on-going development of a plurality of care paths. This can include, as noted, progress status on a phase-by-phase basis and/or on a care path-by-care path basis. This opportunity, in turn, can permit the end user to evaluate the displayed results and/or to edit the process in any of a variety of ways.

These teachings are highly flexible and can be leveraged in various ways depending upon the needs and/or opportunities as tend to characterize a given application setting. For example, as noted, above, these teachings can serve to facilitate identification of a particular care path from amongst a plurality of developed candidate care paths. By one approach this can comprise an automated identification. In other cases, however, it may be impractical or undesirable to expect outputting an automatically-selected best single care path. In such a case, however, these teachings can be readily employed to facilitate automatic generation of a plurality of care paths that can then either be vetted against one another by a human observer (such as an expert clinician) or that can perhaps all be applied when treating the patient.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a control circuit:
developing, in parallel, care paths for at least one corresponding patient, wherein developing the care paths includes serially completing a plurality of corresponding care-path-development phases using input information;
before concluding development of at least one of the care paths, and upon determining a change to the input information during the developing, automatically modifying at least one of the care-path-development phases as a function of the change and redeveloping the care path as corresponds to the modified care-path-development phase.

2. The method of claim 1 wherein the care paths include a plurality of care paths that specify applying therapeutic radiation to the patient.

3. The method of claim 1 wherein the care paths variously include a plurality of differing energy-application modalities.

4. The method of claim 1 wherein developing, in parallel, care paths for at least one corresponding patient includes developing, in parallel, care paths for a plurality of corresponding patients.

5. The method of claim 1 wherein at least one of the care-path-development phases includes contouring a volume within the at least one corresponding patient.

6. The method of claim 1 wherein at least one of the care-path-development phases includes applying a template having default treatment values.

7. The method of claim 1 wherein at least one of the care-path-development phases includes applying values from a previously completed care path.

8. The method of claim 1 further comprising:
automatically terminating further development of one of the care paths as a function of development of another of the care paths.

9. The method of claim 1 further comprising:
simultaneously displaying to an end user of the control circuit at least two of:
progress of the development of the care paths;
prospective care path development steps;
identification of care paths for which development will be undertaken;
retrospective information regarding care path development;
information regarding care paths for which development has been terminated.

10. The method of claim 9 wherein the displaying comprises, at least in part, displaying on a care-path-development phase by care-path-development phase basis.

11. The method of claim 1 wherein developing the care paths comprises using an inverse planning approach to develop at least one of the care paths.

12. The method of claim 1 wherein at least one of the care paths comprises a treatment plan.

13. An apparatus comprising:
a memory having input information stored therein;
a control circuit configured to:
develop, in parallel, care paths for at least one corresponding patient, wherein developing the care paths includes serially completing a plurality of corresponding care-path-development phases using input information;
before concluding development of at least one of the care paths, and upon determining a change to the input information during the developing, automatically modify at least one of the care-path-development phases as a function of the change and redeveloping the care path as corresponds to the modified care-path-development phase.

14. The apparatus of claim 13 wherein the care paths include a plurality of care paths that specify applying therapeutic radiation to the patient.

15. The apparatus of claim 13 wherein the care paths variously include a plurality of differing energy-application modalities.

16. The apparatus of claim 13 wherein the control circuit is configured to develop, in parallel, care paths for at least one corresponding patient by developing, in parallel, care paths for a plurality of corresponding patients.

17. The apparatus of claim 13 wherein at least one of the care-path-development phases includes contouring a volume within the at least one corresponding patient.

18. The apparatus of claim 13 wherein at least one of the care-path-development phases includes applying a template having default treatment values.

19. The apparatus of claim 13 wherein the control circuit is further configured to:
automatically terminate further development of one of the care paths as a function of development of another of the care paths.

20. The apparatus of claim 13 wherein the control circuit is further configured to:
simultaneously display to an end user of the control circuit at least two of:
progress of the development of the care paths;
prospective care path development steps;
identification of care paths for which development will be undertaken;
retrospective information regarding care path development;
information regarding care paths for which development has been terminated.

21. The apparatus of claim 20 wherein the control circuit is configured to simultaneously display to an end user by, at least in part, displaying on a care-path-development phase by care-path-development phase basis.

22. The apparatus of claim 13 wherein the control circuit is configured to develop the care paths by using an inverse planning approach to develop at least one of the care paths.
